(19) United States
(12) Patent Application Publication
(10) Pub. No.: US 2026/0361944 A1
(43) Pub. Date: Nov. 12, 2026

(54) METHOD AND APPARATUS FOR SYNCHRONIZING MULTIPLE MEDIA STREAMS, MEDIUM, AND DEVICE

(71) Applicant: Beijing Zitiao Network Technology Co., Ltd., Beijing (CN)

(72) Inventor: Yuanfeng GONG, Beijing (CN)

(21) Appl. No.: 19/486,656

(22) PCT Filed: May 20, 2024
(86) PCT No.: PCT/CN2024/094181

§ 371 Date: Nov. 21, 2025

(30) Foreign Application Priority Data
May 23, 2023 (CN) 202310583556.7

(51) Int. Cl. H04N 21/43; H04N 21/8547

(52) U.S. Cl. CPC H04N 21/43072; H04N 21/8547

(57) ABSTRACT

Embodiments of the present description provide a method and apparatus for synchronizing multiple media streams, a medium, and a device. A specific embodiment of the method comprises: in response to receiving a media data packet of a target media stream, according to a current timestamp modifier of a received first media stream, determining an initial timestamp modifier of the media data packet of the target media stream, wherein the target media stream is a media stream received after the first media stream; determining a relative delay of the target media stream relative to the first media stream; updating the timestamp modifier of each received media stream according to the relative delay; and modifying the timestamp of a data packet of each media stream according to the time stamp modifier of each media stream.

### CROSS-REFERENCE TO RELATED APPLICATIONS

The present application is based on and claims the priority to the Chinese application No. 202310583556.7 entitled “METHOD AND APPARATUS FOR SYNCHRONIZING MULTIPLE MEDIA STREAMS, MEDIUM, AND DEVICE” filed on May 23, 2023, the disclosure of which is incorporated herein in its entirety.

### TECHNICAL FIELD

Embodiments of the present description relate to the field of information technology, and in particular, to a method and apparatus for synchronizing multiple media streams, a medium, and a device.

### BACKGROUND

With the rapid development of computer technology and Internet technology, applications relating to multimedia data have been more and more popular, and are much loved by users.

### SUMMARY

In the embodiments of the present description, a method and apparatus for synchronizing multiple media streams, a medium, and a device are described, where when a target media stream is received, based on a relative delay of the target media stream relative to a first media stream, a time stamp of a data packet of each media stream may be modified, thereby synchronizing the multiple media streams in real time.

According to a first aspect, there is provided a method for synchronizing multiple media streams, including: determining, in response to receiving a media data packet of a target media stream, an initial time stamp modifier of the media data packet of the target media stream according to a current time stamp modifier of a received first media stream; determining a relative delay of the target media stream relative to the first media stream; updating a time stamp modifier of each received media stream according to the relative delay; and modifying a time stamp of a data packet of each media stream according to the time stamp modifier of each media stream.

In an embodiment, the updating a time stamp modifier of each received media stream according to the relative delay, includes: determining a relative size relationship between a delay of the target media stream and a delay of the first media stream according to the relative delay; and increasing, in response to determining that the delay of the target media stream is less than the delay of the first media stream, a modifier corresponding to the relative delay on a current time stamp modifier of each received media stream other than the target media stream. Thereby, the media streams are synchronized when the delay of the target media stream is less than the delay of the first media stream.

In an embodiment, the updating a time stamp modifier of each received media stream according to the relative delay further, includes: increasing, in response to determining that the delay of the target media stream is greater than the delay of the first media stream, the modifier corresponding to the relative delay on a current time stamp modifier of the target media stream. Thereby, the media streams are synchronized when the delay of the target media stream is greater than the delay of the first media stream.

In an embodiment, the method further includes: receiving synchronous information of the target media stream; and the determining a relative delay of the target media stream relative to the first media stream, includes: calculating the relative delay of the target media stream relative to the first media stream according to the synchronization information of the target media stream and synchronization information of the first media stream received in advance, where the synchronization information includes time information in a sender report. Thereby, the relative delay between the media streams is determined based on the time information in the sender report.

In an embodiment, before the determining a relative delay of the target media stream relative to the first media stream, the method further includes: receiving and storing the synchronization information of the first media stream. Thereby, the synchronization information of the first media stream is received and stored.

In an embodiment, before the receiving a media data packet of a target media stream, the method further includes: receiving a data packet of the first media stream, and setting an initial time stamp modifier of the first media stream to 0. Thereby, the initial time stamp modifier of the first media stream is set.

In an embodiment, before the receiving a media data packet of the target media stream, media data packet(s) of one or more media streams has(have) been received. Thereby, two or more media streams including the target media stream are synchronized.

According to a second aspect, there is provided an apparatus for synchronizing multiple media streams, including: a first determining unit configured to determine, in response to receiving a media data packet of a target media stream, an initial time stamp modifier of the media data packet of the target media stream according to a current time stamp modifier of a received first media stream; a second determining unit configured to determine a relative delay of the target media stream relative to the first media stream; an updating unit configured to update a time stamp modifier of each received media stream according to the relative delay; and a modifying unit configured to modify a time stamp of a data packet of each media stream according to the time stamp modifier of each media stream.

According to a third aspect, there is provided a computer program product, including a computer program which, when executed by a processor, implements the method according to any of the first aspect.

According to a fourth aspect, there is provided a computer-readable storage medium having thereon stored a computer program which, when executed in a computer, causes the computer to perform the method according to any of the first aspect.

According to a fifth aspect, there is provided an electronic device, including a memory and a processor, the memory having executable code stored therein, and the processor, when executing the executable code, implementing the method according to any of the first aspect.

According to the method and apparatus for synchronizing multiple media streams provided by the embodiments of the present description, when a media data packet of a target media stream is received, an initial time stamp modifier of the media data packet of the target media stream can be determined according to a current time stamp modifier of a first media stream. Then, a relative delay of the target media stream relative to the first media stream is determined, and a time stamp modifier of each received media stream is updated according to the relative delay. Finally, a time stamp of a data packet of each media stream is modified according to the time stamp modifier of each media stream. Thus, when the target media stream is received, the time stamp of the data packet of each media stream can be modified based on the relative delay of the target media stream relative to the first media stream, thereby synchronizing the multiple media streams (including a new media stream received at any time) in real time.

### BRIEF DESCRIPTION OF THE DRAWINGS

FIG. 1 shows a schematic diagram of one application scenario in which an embodiment of the present specification can be applied;

FIG. 2 shows a flowchart of a method for synchronizing multiple media streams according to one embodiment;

FIG. 3(a) shows a schematic diagram of timeline distribution of 5 media streams in a misalignment state;

FIG. 3(b) shows a schematic effect diagram after a first media stream, a later media stream (2), a later media stream (3), and a later media stream (4) are moved downwards by t1;

FIG. 3(c) shows a schematic effect diagram after a later media stream (2) is moved downwards by t0;

FIG. 3(d) shows a schematic effect diagram after a first media stream, a later media stream (1), a later media stream (2), and a later media stream (4) are moved downwards by t1;

FIG. 3(e) shows a schematic effect diagram after a first media stream, a later media stream (1), a later media stream (2), and a later media stream (3) are moved downwards by t2;

FIG. 4 shows a schematic block diagram of an apparatus for synchronizing multiple media streams according to one embodiment;

FIG. 5 shows a schematic structural diagram of an electronic device suitable for implementing embodiments of the present application.

### DETAILED DESCRIPTION

The technical solutions provided in the present specification will further described in detail below with reference to the accompanying drawings and the embodiments. It can be understood that the specific embodiments described herein are merely used for illustration of the related invention, rather than limitation of this invention. In addition, it should be noted that, for convenience of description, only the portions related to the present invention are shown in the drawings. It should be noted that the embodiments in the present specification and features in the embodiments may be combined with each other without conflict.

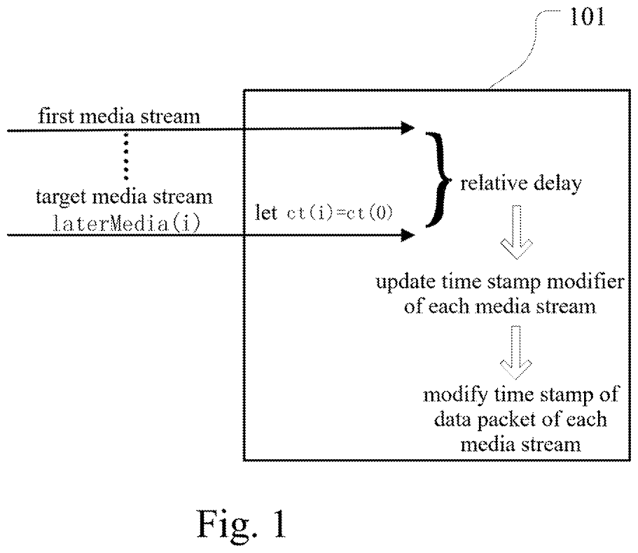

When there are multiple media streams, there is a need to synchronize the multiple media streams. Taking an example of a scenario such as a live and a video conference, real-time time synchronization of multimedia data is very necessary, because this relates to whether media streams are synchronized when played. To this end, in the embodiments of the present description, there is provided a method for synchronizing multiple media streams, thereby synchronizing the multiple media streams. As shown in FIG. 1, FIG. 1 shows a schematic diagram of one application scenario in which an embodiment of the present specification can be applied. In the application scenario shown in FIG. 1, a device 101 may receive multiple media streams, and each time it receives one new media stream, after receiving related data for synchronization of the media stream, it can perform synchronization once based on the related data for synchronization of the media stream. In synchronization, a time stamp of a data packet of each received media stream may be modified. The time stamp of the data packet to be modified here may include a DTS (Decoding Time Stamp) and a PTS (Presentation Time Stamp). In this example, an example is taken that a received first media stream is firstMedia, a current time stamp modifier of the first media stream is ct(0), and media streams received after the first media stream are, in turn, a later media stream (1) laterMedia(1), a later media stream (2) laterMedia(2), . . . , where the current time stamp modifier of the first media stream may refer to a change in a time stamp of the first media stream at a current time compared with an original time stamp. When a media data packet of a target media stream, laterMedia(i) (where i=1 and is a positive integer) is received, an initial time stamp modifier of the media data packet of the target media stream can be determined according to the current time stamp modifier ct(0) of the first media stream. That is, a time stamp modifier ct(i) of the target media stream is initialized, for example, it is possible to let ct(i)=ct(0) in initialization. At this time, a time stamp of the media data packet of the target media stream can be modified according to ct(i), thereby making the target media stream inherit the current time stamp modifier of the first media stream, without changing an original relative delay between the target media stream and the first media stream. Then, it is possible to receive related data for synchronization of the target media stream, and determine a relative delay relative_delay(i) of the target media stream relative to the first media stream according to the related data for synchronization. Then, a time stamp modifier of each received media stream is updated according to relative_delay(i). Finally, a time stamp of a data packet of each media stream is modified according to the time stamp modifier of each media stream. Thereby, the multiple media streams can be synchronized.

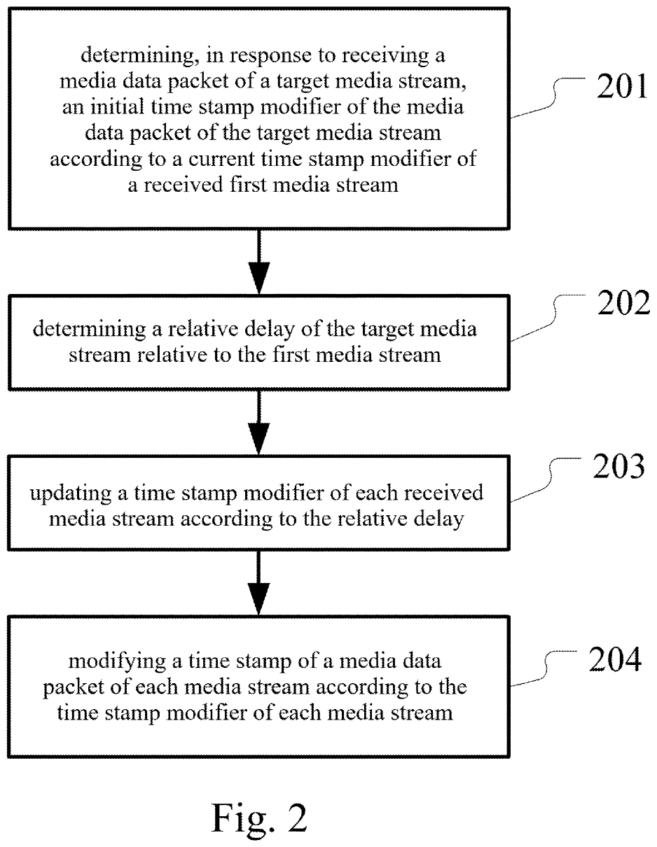

Continually referring to FIG. 2, FIG. 2 illustrates a flowchart of a method for synchronizing multiple media streams according to one embodiment. The method may be executed by any apparatus, device, platform, device cluster having computing and processing capabilities. For example, it may be executed by a terminal device. For another example, after executed by another apparatus, device, or the like, synchronized multiple media streams may also be transmitted to a terminal device. As shown in FIG. 2, the method for synchronizing multiple media streams may include:
step 201, determining, in response to receiving a media data packet of a target media stream, an initial time stamp modifier of the media data packet of the target media stream according to a current time stamp modifier of a received first media stream.

In this embodiment, the media stream may include a video stream, an audio stream, a subtitle stream, and the like. The media data packet may refer to a data packet containing media data. Taking a video stream as an example, a media data packet may refer to a data packet containing a video frame. When a media data packet of a target media stream is received, an initial time stamp modifier of the media data packet of the target media stream may be determined according to a current time stamp modifier of a received first media stream. For example, the current time stamp modifier of the first media stream may be taken as the initial time stamp modifier of the target media stream. Then, a time stamp of the media data packet of the target media stream may be modified according to the initial time stamp modifier. In this way, the target media stream may inherit the current time stamp modifier of the first media stream, thereby making a relative delay between the target media stream and the first media unchanged. In this example, the target media stream is a media stream received after the first media stream.

It can be understood that before the receiving a media data packet of a target media stream, media data packet(s) of one or more media stream(s) has(have) been received. That is, the target media stream is a received Nth media stream, where N=2, and N is a positive integer. Thereby, two or more media streams including the target media stream can be synchronized.

In some implementations, before the receiving a media data packet of a target media stream, the method for synchronizing multiple media streams may further include: receiving a data packet of the first media stream, and setting an initial time stamp modifier of the first media stream to 0. Thereby, the initial time stamp modifier of the first media stream may be set.

Step 202, determining a relative delay of the target media stream relative to the first media stream.

In this embodiment, a relative delay of the target media stream relative to the first media stream may be determined in a number of ways.

As an example, delay information of a media stream may be carried in an RTCP (Real-time Transport Control Protocol) message of the media stream, for example, the delay information may include a value, delay, of one delay. In this way, the relative delay of the target media stream relative to the first media stream may be calculated according to delay information of the target media stream and delay information of the first media stream. Taking an example that the target media stream is laterMedia(i) and the first media stream is firstMedia, where i≥1, and i is a positive integer, the relative delay, relative_delay(i), of laterMedia(i) relative to firstMedia can be determined by:

relative_delay(i)=FirstMedia.delay−laterMedia(i).delay,
where FirstMedia.delay may represent a value of the delay of firstMedia, and laterMedia(i).delay may represent a value of the delay of laterMedia(i).

As another example, a relative delay of one media stream relative to the first media stream may also be carried directly in an RTCP message of the media stream. In this way, the relative delay of the target media stream relative to the first media stream may be determined directly from the RTCP message.

It can be appreciated that, the RTCP messages in the above two examples may be received after part of the media data packet of the target media stream is received. Therefore, synchronization may not be performed when a first media data packet of the target media stream is received, but may be performed after the part of the media data packet is received.

In some implementations, the method for synchronizing multiple media streams may further include the following step not shown in FIG. 2: receiving synchronization information of the target media stream.

In this implementation, the synchronization information may include ntp (Network Time Protocol) and rtp (Real-Time Transport Protocol) time information carried in an RTCP sender report (SR).

Based on this, the above step 202 may be specifically performed as follows: calculating the relative delay of the target media stream relative to the first media stream according to the synchronization information of the target media stream and synchronization information of the first media stream received in advance.

It can be appreciated that, the synchronization information of the first media stream may be received and stored before that. That is, the target media stream is a received 2nd or n-th (where n>2, and n is a positive integer) media stream.

Taking an example that the first media stream is firstMedia and the target media stream is laterMedia(i), the relative delay, relative_delay(i), of laterMedia(i) relative to firstMedia can be determined as follows:

relative_delay(i)=(FirstMedia.RtpPts−laterMedia(i).RtpPts)−(FirstMedia.NtpTime−laterMedia(i).NtpTime),
where RtpPts=rtpTimestamp/clockRate, rtpTimestamp may represent a rtp time stamp, clockRate may represent a clock frequency, and NtpTime may represent a ntp time stamp. FirstMedia.RtpPts may represent RtpPts of firstMedia.laterMedia(i). RtpPts may represent RtpPts of lateMedia(i). FirstMedia.NtpTime may represent NtpTime of FirstMedia.laterMedia(i). NtpTime may represent NtpTime of laterMedia(i).

In practice, by means of the synchronization information, i.e., a time stamp pair, <rtp, ntp>, contained in the SR of the RTCP, it is possible to position firstMedia and laterMedia(i) onto one absolute timeline, and then calculate a difference, i.e., a relative deviation for the timeline, that is, the relative delay. Thereby, the relative delay between the media streams may be determined based on the time information in the sender report.

Step 203, updating a time stamp modifier of each received media stream according to the relative delay.

In this embodiment, a current time stamp modifier of each received media stream may be updated according to the relative delay determined in the step 202. For example, a time stamp modifier of the received target media stream may be updated according to the relative delay, thereby eliminating the relative delay between the target media stream and the first media stream to implement synchronization. For another example, a time stamp modifier of each media stream received before the target media stream is updated according to the relative delay, thereby eliminating the relative delay between other media streams including the first media stream and the target media stream to implement synchronization. Although synchronization is implemented in the two examples described above, a problem of time stamp back-off is not considered in the two examples described above.

In practice, for data packets in one media stream, time stamps thereof should be monotonously non-decreasing with the increase of data packet sequence numbers, and the time stamp back-off should not occur. For example, assuming that a certain media stream includes 1000 data packets with data packet sequence numbers 1-1000, in theory, time stamps of the data packets should be monotonously non-decreasing with the monotonous increase of the sequence numbers. Otherwise, time stamp back-off occurs. For example, if a time stamp of a data packet with the sequence number of 102 is less than a time stamp of a data packet with the sequence number of 101, the occurrence of time stamp back-off is indicated. If the time stamp back-off occurs, subsequent decoding, rendering, playing, etc. of media data may be affected. Therefore, the problem of time stamp back-off should be avoided when the media streams are synchronized.

In order to avoid the problem of time stamp back-off, the step 203 may be specifically implemented as follows:
S1, determining a relative size relationship between a delay of the target media stream and a delay of the first media stream according to the relative delay.

In this implementation, it is possible to determine, according to the relative delay, for the target media stream and the first media stream, whose delay is greater and whose delay is less.
S2, increasing, in response to determining that the delay of the target media stream is less than the delay of the first media stream, a modifier corresponding to the relative delay on a current time stamp modifier of each received media stream other than the target media stream.

In this implementation, if the delay of the target media stream is less than the delay of the first media stream, it is indicated that when data packets are transmitted at a same time, the data packet of the target media stream arrives earlier. Thereby, a time stamp of the data packet of the target media stream received at a certain time may be greater. Therefore, there is a need to increase the delay of the target media stream, i.e. to decrease the time stamp of the data packet of the target media stream, but this may cause the problem of time stamp back-off. In order to avoid the problem of time stamp back-off, it is possible to decrease a delay of each received media stream other than the target media stream, i.e., increase a modifier corresponding to the relative delay on a current time stamp modifier of each received media stream other than the target media stream. For example, assuming that the relative delay is 0.01 ms (millisecond), 0.01 ms may be taken as a modifier corresponding to the relative delay.
S3, increasing, in response to determining that the delay of the target media stream is greater than the delay of the first media stream, the modifier corresponding to the relative delay on a current time stamp modifier of the target media stream.

In this implementation, if the delay of the target media stream is greater than the delay of the first media stream, it is indicated that when data packets are transmitted at a same time, the data packet of the target media stream arrives later. Thereby, a time stamp of the data packet of the target media stream received at a certain time may be less. Therefore, there is a need to decrease the delay of the target media stream, i.e. to increase the time stamp of the data packet of the target media stream. However, increasing the time stamp of the data packet will not cause time stamp back-off, so that when the delay of the target media stream is greater than the delay of the first media stream, a modifier corresponding to the relative delay can be directly increased on a current time stamp modifier of the target media stream to implement time synchronization.

With this implementation, time synchronization based on the relative size relationship between the delay of the target media stream and the delay of the first media stream is implemented, and the time stamp modifiers of those media streams are selected and updated according to the relative size relationship between the delays, and this better accords with the actual situation and will not cause the dts back-off of the media data packet, thereby making the synchronization process more reasonable and the application range of the method wider.

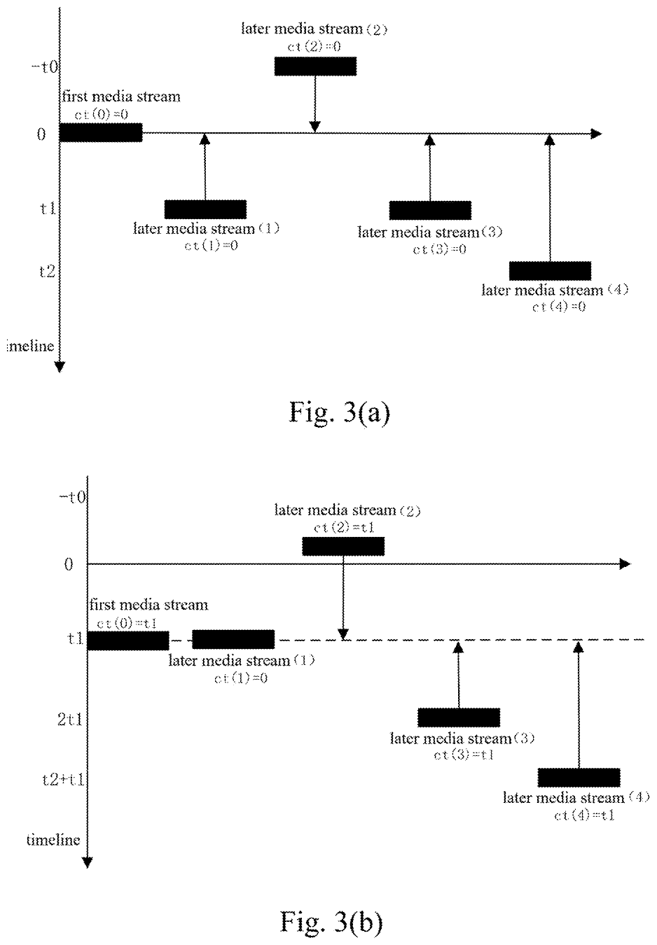

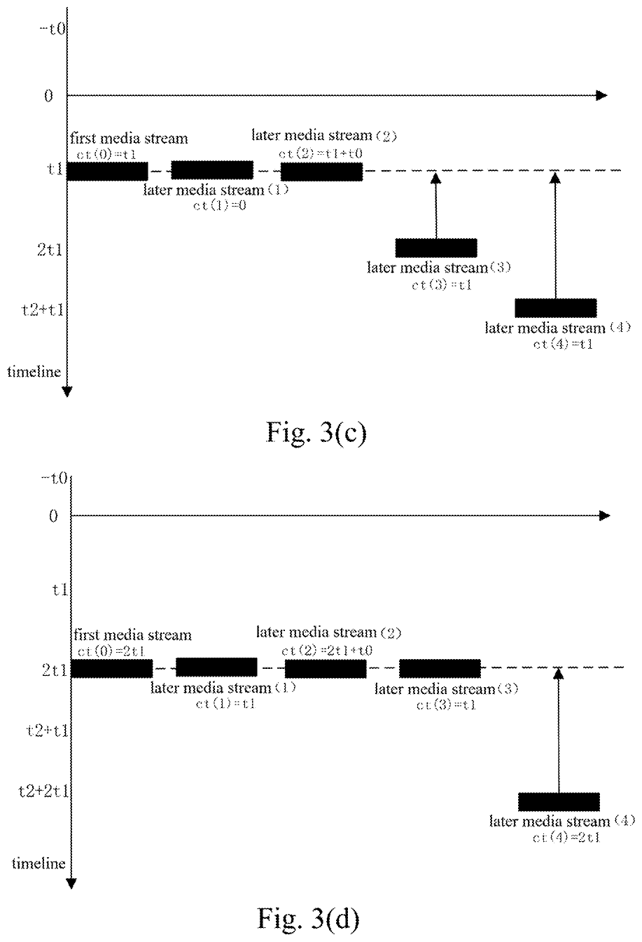

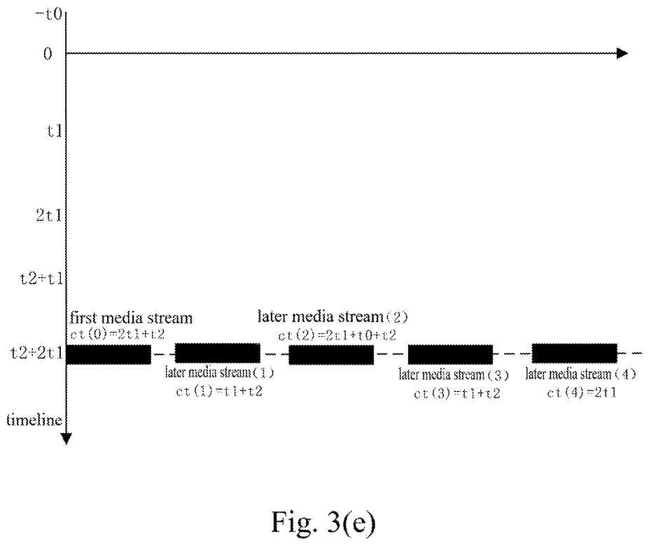

Continually referring to FIG. 3(a)-3(e), FIG. 3(a)-3(e) illustrate exemplary diagrams of synchronizing 5 media streams. In the examples shown in FIG. 3(a)-3(e), a first media stream firstMedia, a later media stream (1) laterMedia1, a later media stream (2) laterMedia2, a later media stream (3) laterMedia3, and a later media stream (4) laterMedia 4, in a reception order of the media streams are included, 5 media streams in total.

FIG. 3(a) shows a schematic diagram of timeline distribution of 5 media streams in a misalignment state. In FIG. 3(a), a current time stamp modifier ct of each media stream is 0. That is, ct(0) corresponding to the first media stream=0, ct(1) corresponding to the later media stream (1)=0, ct(2) corresponding to the later media stream (2)=0, ct(3) corresponding to the later media stream (3)=0, and ct(4) corresponding to the later media stream (4) =0. In FIG. 3 (a), a vertical ordinate represents a timeline. If two media streams are on a same horizontal line, it is considered that the two media streams are synchronized in time. In FIG. 3(a), the 5 media streams are not on a same horizontal line, so that synchronization is needed. If each laterMedia is moved in a direction of an arrow in the figure, synchronization can be implemented. However, the media stream cannot be moved according to an upward arrow since moving the media stream upwards may cause non-increasing of a time stamp, and may cause back-off of the time stamp. Therefore, there is a need to translate other media streams downwards.

Based on the above description, when the later media stream (1) is aligned with the first media stream, the later media stream (1) cannot be moved upwards, so that there is a need to move the first media stream downwards by t1. If only the first media stream is moved, a relative delay of the other laterMedia with the first media stream is affected, so that the later media stream (2), the later media stream (3) and the later media stream (4) also need corresponding movement with the first media stream, also downward movement by t1. An effect after the movement is shown in FIG. 3(b), which shows a schematic effect diagram after the first media stream, the later media stream (2), the later media stream (3) and the later media stream (4) are moved downwards by t1. At this time, ct(0)=t1, ct(1)=0, ct(2)=t1, ct(3)=t1, ct(4)=t1.

For the later media stream (2), in synchronization, since alignment of the later media stream (2) will not cause back-off of time stamp, the later media stream (2) can be directly moved downwards by t0 for alignment, without affecting other media streams. FIG. 3(c) shows a schematic effect diagram after the later media stream (2) is moved downwards by t0. At this time, ct(0)=t1, ct(1)=0, ct(2)=t1+t0, ct(3)=t1, ct(4)=t1.

For the later media stream (3), in synchronization, since the later media stream (3) cannot move upwards, there is a need to move the first media stream, the later media stream (1), the later media stream (2), and the later media stream (4) downwards by t1. FIG. 3(d) shows a schematic effect diagram after the first media stream, the later media stream (1), the later media stream (2) and the later media stream (4) are moved downwards by t1. At this time, ct(0)=2t1, ct(1)=t1, ct(2)=2t1+t0, ct(3)=t1, ct(4)=2t1.

For the later media stream (4), in synchronization, since the later media stream (4) cannot move upwards, there is a need to move the first media stream, the later media stream (1), the later media stream (2), and the later media stream (3) downwards by t2. FIG. 3(e) shows a schematic effect diagram after the first media stream, the later media stream (1), the later media stream (2) and the later media stream (3) are moved downwards by t2. At this time, ct(0)=2t1+t2, ct(1)=t1+t2, ct(2)=2t1+t0+t2, ct(3)=t1+t2, and ct(4)=2t1.

The time synchronization of the 5 media streams can be completed by the translation processes shown in FIG. 3(a)-3(e). Thereafter, if a new media stream is received, it is possible to first make the new media stream inherit a current value of ct(0) of the first media stream. Then, synchronization is performed. For the specific synchronization, reference may be made to the synchronization of the later media stream (1), the later media stream (2), the later media stream (3), and the later media stream (4), which will not be repeated herein. Therefore, the method of the present application can implement synchronization of a new media stream received at any time.

It can be understood that, for some applications such as a live and video conference in unreliable transmission scenarios, for example, udp (User Datagram Protocol)/rtp (Real-Time Transport Protocol) transmission based on webrtc (Web Real-Time Communications), due to unreliability of network transmission, a data packet to which data for calculating a relative delay belongs may be received later or even lost, and thus, a time for media stream synchronization may be affected. However, in the method of the present application, an original relative delay with other media streams will not change before the synchronization.

Step 204, modifying a time stamp of a media data packet of each media stream according to the time stamp modifier of each media stream.

In this embodiment, it is possible to modify a time stamp of a data packet of each media stream according to the time stamp modifier of each media stream, thereby implementing time synchronization. As an example, time stamps of all data packets of the media stream may be modified, in this example, it is possible to first buffer all the received media data packets until related data for synchronization is received, and after the synchronization operation is performed, read out the buffered media data packets and modify the time stamps according to the synchronization result, for synchronization. However, in this way, the buffering will increase a delay, while for a scenario such as a live and video conference, the delay should be decreased as much as possible. In addition, in an unreliable transmission scenario, it cannot be ensured when the related data for synchronization is obtained, so that a duration for the buffering is uncontrollable. As another example, it is also possible to modify only the time stamp of the data packet after synchronization, without modifying the time stamp of the data packet before synchronization, in this example, the data packet before synchronization is not buffered, and the time stamp of the target media stream is modified only according to the initial time stamp modifier of the target media stream, thereby not changing its original relative delay with the first media stream. After synchronization, the time stamp of the data packet after synchronization is modified. In this way, buffering can be avoided, which can ensure time synchronization of the media stream after synchronization.

Looking back at the above process, in the above embodiments of the present description, when a media data packet of a target media stream is received, an initial time stamp modifier of the media data packet of the target media stream may be determined according to a current time stamp modifier of a first media stream. Then, a relative delay of the target media stream relative to the first media stream is determined, and a time stamp modifier of each received media stream is updated according to the relative delay. Finally, a time stamp of a data packet of each media stream is modified according to the time stamp modifier of each media stream. Therefore, when the target media stream is received, the time stamp of the data packet of each media stream can be modified based on the relative delay of the target media stream relative to the first media stream, thereby synchronizing multiple media streams (including a new media stream received at any time) in real time.

According to an embodiment of another aspect, there is provided an apparatus for synchronizing multiple media streams. The apparatus for synchronizing multiple media streams can be deployed in any apparatus, device, platform, and device cluster with computing and processing capabilities.

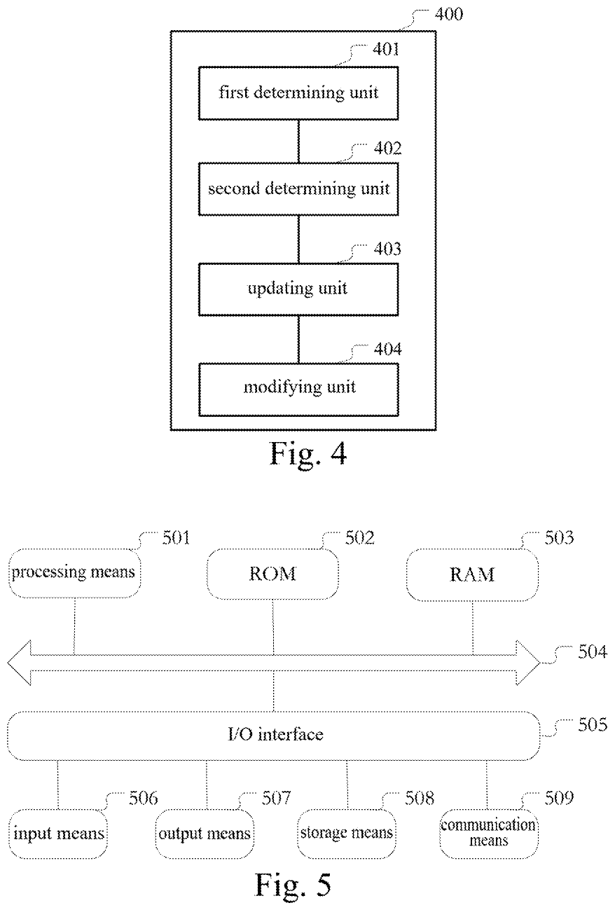

FIG. 4 shows a schematic block diagram of an apparatus for synchronizing multiple media streams according to one embodiment. The apparatus shown in FIG. 4 is used for performing the method shown in FIG. 2. As shown in FIG. 4, the apparatus 400 for synchronizing multiple media streams includes: a first determining unit 401 configured to determine, in response to receiving a media data packet of a target media stream, an initial time stamp modifier of the media data packet of the target media stream according to a current time stamp modifier of a received first media stream, where the target media stream is a media stream received after the first media stream; a second determining unit 402 configured to determine a relative delay of the target media stream relative to the first media stream; an updating unit 403 configured to update a time stamp modifier of each received media stream according to the relative delay; and a modifying unit 404 configured to modify a time stamp of a data packet of each media stream according to the time stamp modifier of each media stream.

In some optional implementations of this embodiment, the updating unit 403 is further configured to: determine a relative size relationship between a delay of the target media stream and a delay of the first media stream according to the relative delay; and increase, in response to determining that the delay of the target media stream is less than the delay of the first media stream, a modifier corresponding to the relative delay on a current time stamp modifier of each received media stream other than the target media stream.

In some optional implementations of this embodiment, the updating unit 403 is further configured to: increase, in response to determining that the delay of the target media stream is greater than the delay of the first media stream, the modifier corresponding to the relative delay on a current time stamp modifier of the target media stream.

In some optional implementations of this embodiment, the apparatus 400 further includes: a receiving unit (not shown in the figure) configured to receive synchronization information of the target media stream; and the second determining unit 402 is further configured to: calculate the relative delay of the target media stream relative to the first media stream according to the synchronization information of the target media stream and synchronization information of the first media stream received in advance, where the synchronization information includes time information in a sender report.

In some optional implementations of this embodiment, the apparatus 400 further includes: a receiving and storing unit (not shown in the figure) configured to receive and store the synchronization information of the first media stream.

In some optional implementations of this embodiment, the apparatus 400 further includes: a setting unit (not shown in the figure) configured to receive a data packet of the first media stream and set an initial time stamp modifier of the first media stream to 0.

In some optional implementations of this embodiment, before the receiving a media data packet of a target media stream, media data packet(s) of one or more media streams has(have) been received.

The above apparatus embodiments correspond to the method embodiments, and for the specific description thereof, reference may be made to the description of the method embodiments, which will not be repeated herein. The apparatus embodiments are obtained based on the corresponding method embodiments, have the same technical effects as the corresponding method embodiments, and for the specific description thereof, reference may be made to the corresponding method embodiments.

According to an embodiment of another aspect, there is also provided a computer-readable storage medium having thereon stored a computer program which when executed in a computer, causes the computer to perform the method described in FIG. 2.

According to an embodiment of still another aspect, there is also provided an electronic device, including a memory and a processor, characterized in that the memory has executable code stored therein, and the processor, when executing the executable code, implements the method described in FIG. 2.

The specific embodiments of the present specification have been described in the above, and other embodiments are within the scope of the appended claims. In some cases, the actions or steps recited in the claims can be performed in a different order than those in the embodiments, and desirable results can still be achieved. In addition, the processes depicted in the accompanying drawings are not necessarily in the specific order shown or in a continuous order to achieve desirable results. In some implementations, multitasking processing and parallel processing are also possible or may be advantageous.

Referring to FIG. 5 below, it shows a schematic structural diagram of an electronic device 500 suitable for implementing the embodiments of the present application. The electronic device shown in FIG. 5 is only an example, and should not bring any limitation to the functions and the scope of use of the embodiments of the present application.

As shown in FIG. 5, the electronic device 500 may include a processing means (e.g., central processing unit, graphics processing unit, etc.) 501, which may perform various appropriate actions and processes according to a program stored in a read-only memory (ROM) 502 or a program loaded from a storage means 508 into a random access memory (RAM) 503. In the RAM503, various programs and data required for the operation of the electronic device 500 are also stored. The processing means 501, the ROM 502, and the RAM 503 are connected to each other by a bus 504. An input/output (I/O) interface 505 is also connected to the bus 504.

Generally, the following means may be connected to the I/O interface 505: an input means 506 including, for example, a touch screen, a touch pad, a keyboard, a mouse, etc.; an output means 507 including, for example, a liquid crystal display (LCD), a speaker, a vibrator, etc.; the storage means 508 including, for example, a magnetic tape, a hard disk, etc.; and a communication means 509. The communication means 509 may allow the electronic device 500 to communicate with other devices wirelessly or by wire to exchange data. While FIG. 5 illustrates the electronic device 500 having various means, it should be understood that there is no requirement that all the illustrated means are implemented or provided. More or fewer means may be alternatively implemented or provided. Each block shown in FIG. 5 may represent one means or may represent a plurality of means as needed.

In particular, the processes described above with reference to the flowcharts may be implemented as a computer software program according to the embodiments of the present application. For example, an embodiment of the present application includes a computer program product, which includes a computer program carried on a computer-readable medium, the computer program including program code for performing the method illustrated by the flowcharts. In such an embodiment, the computer program may be downloaded and installed from a network via the communication means 509, or installed from the storage means 508, or installed from the ROM 502. The computer program, when executed by the processing means 501, performs the above functions defined in the method of the embodiment of the present application.

In an embodiment of the present description, there is also provided a computer-readable storage medium having thereon stored a computer program which when executed in a computer, causes the computer to perform the method provided in the present specification.

It should be noted that the computer-readable medium described in the embodiment of the present description may be a computer-readable signal medium or a computer-readable storage medium or any combination of the two. The computer-readable storage medium may be, for example, but not limited to, an electronic, magnetic, optical, electromagnetic, infrared, or semiconductor system, apparatus, or device, or any combination of the foregoing. More specific examples of the computer-readable storage medium may include, but are not limited to: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the embodiments of this description, the computer-readable storage medium may be any tangible medium containing or storing a program which can be used by or in conjunction with an instruction execution system, apparatus, or device. However, in the embodiments of this description, the computer-readable signal medium may include a data signal propagated in baseband or as part of a carrier wave, in which computer-readable program code is carried. Such a propagated data signal may take any of a variety of forms, including, but not limited to, an electromagnetic signal, an optical signal, or any suitable combination of the forgoing. The computer-readable signal medium may also be any computer-readable medium other than the computer-readable storage medium, and the computer-readable signal medium can send, propagate, or transmit a program for use by or in conjunction with an instruction execution system, apparatus, or device. The program code contained on the computer-readable medium may be transmitted using any appropriate medium, including but not limited to: an electrical wire, optical cable, RF (Radio Frequency), etc., or any suitable combination of the foregoing.

The computer-readable medium may be contained in the electronic device; or may exist separately, without being assembled into the electronic device. The computer-readable medium has thereon carried one or more programs which, when executed by the electronic device, cause the electronic device to: determine, in response to receiving a media data packet of a target media stream, an initial time stamp modifier of the media data packet of the target media stream according to a current time stamp modifier of a received first media stream; determine a relative delay of the target media stream relative to the first media stream; updating a time stamp modifier of each received media stream according to the relative delay; and modifying a time stamp of a data packet of each media stream according to the time stamp modifier of each media stream.

Computer program code for performing operations for the embodiments of the present description may be written in one or more programming languages or a combination thereof, the programming language including an object-oriented programming language such as Java, Smalltalk, and C++, and also including a conventional procedural programming language, such as the “C” programming language or a similar programming language. The program code may be executed entirely on a user's computer, partly on a user's computer, as a stand-alone software package, partly on a user's computer and partly on a remote computer, or entirely on a remote computer or electronic device. In a scenario that relates to a remote computer, the remote computer may be connected to a user's computer through any type of network, including a local area network (LAN) or a wide area network (WAN), or may be connected to an external computer (for example, through the Internet using an Internet service provider).

The embodiments in the present description are described in a progressive manner, for same and similar parts between the embodiments, reference can be made to each other, and each embodiment focuses on differences from other embodiments. In particular, for the storage medium and computing device embodiments, since they are substantially similar to the method embodiments, the description is relatively simple, and reference may be made to the description of the method embodiments for related points.

Those skilled in the art should realize that, in one or more of the examples described above, the functions described in the embodiments of the present disclosure may be implemented using hardware, software, firmware, or any combination thereof. When implemented using software, the functions may be stored in a computer-readable medium, or used as one or more instructions or code on a computer-readable medium for transmission.

In the specific implementations described above, the objectives, technical solutions and beneficial effects of the embodiments of the present disclosure are further described in detail. It should be understood that the above description is only the specific implementations of the embodiments of the present disclosure, and is not intended to limit the scope of protection of the present disclosure, and any modification, equivalent substitution, improvement and the like made on the basis of the technical solutions of the present disclosure should be included in the scope of protection of the present disclosure.

1. A method for synchronizing multiple media streams, comprising:
determining, in response to receiving a media data packet of a target media stream, an initial time stamp modifier of the media data packet of the target media stream according to a current time stamp modifier of a received first media stream, wherein, the target media stream is a media stream received after the first media stream;
determining a relative delay of the target media stream relative to the first media stream;
updating a time stamp modifier of each received media stream according to the relative delay; and
modifying a time stamp of a data packet of each media stream according to the time stamp modifier of each media stream.

2. The method according to claim 1, wherein, the updating a time stamp modifier of each received media stream according to the relative delay, comprises:
determining a relative size relationship between a delay of the target media stream and a delay of the first media stream according to the relative delay; and
increasing, in response to determining that the delay of the target media stream is less than the delay of the first media stream, a modifier corresponding to the relative delay on a current time stamp modifier of each received media stream other than the target media stream.

3. The method according to claim 2, wherein, the updating a time stamp modifier of each received media stream according to the relative delay, further comprises:
increasing, in response to determining that the delay of the target media stream is greater than the delay of the first media stream, the modifier corresponding to the relative delay on a current time stamp modifier of the target media stream.

4. The method according to claim 1, wherein, the method further comprises:
receiving synchronization information of the target media stream; and
the determining a relative delay of the target media stream relative to the first media stream, comprises:
calculating the relative delay of the target media stream relative to the first media stream according to the synchronization information of the target media stream and synchronization information of the first media stream received in advance, wherein, the synchronization information comprises time information in a sender report.

5. The method according to claim 4, wherein, before the determining a relative delay of the target media stream relative to the first media stream, the method further comprises:
receiving and storing the synchronization information of the first media stream.

6. The method according to claim 1, wherein, before the receiving a media data packet of a target media stream, the method further comprises:
receiving a data packet of the first media stream, and setting an initial time stamp modifier of the first media stream to 0.

7. The method according to claim 1, wherein, before the receiving a media data packet of the target media stream, media data packet(s) of one or more media streams has(have) been received.

8. (canceled)

9. (canceled)

10. (canceled)

11. (canceled)

12. (canceled)

13. A non-transitory computer-readable storage medium having thereon stored a computer program which, when executed in a computer, causes the computer to perform a method for synchronizing multiple media streams, comprising:
determining, in response to receiving a media data packet of a target media stream, an initial time stamp modifier of the media data packet of the target media stream according to a current time stamp modifier of a received first media stream, wherein, the target media stream is a media stream received after the first media stream;
determining a relative delay of the target media stream relative to the first media stream;
updating a time stamp modifier of each received media stream according to the relative delay; and
modifying a time stamp of a data packet of each media stream according to the time stamp modifier of each media stream.

14. The medium according to claim 13, wherein, the updating a time stamp modifier of each received media stream according to the relative delay, comprises:
determining a relative size relationship between a delay of the target media stream and a delay of the first media stream according to the relative delay; and
increasing, in response to determining that the delay of the target media stream is less than the delay of the first media stream, a modifier corresponding to the relative delay on a current time stamp modifier of each received media stream other than the target media stream.

15. The medium according to claim 14, wherein, the updating a time stamp modifier of each received media stream according to the relative delay, further comprises:
increasing, in response to determining that the delay of the target media stream is greater than the delay of the first media stream, the modifier corresponding to the relative delay on a current time stamp modifier of the target media stream.

16. The medium according to claim 13, wherein, the method further comprises:
receiving synchronization information of the target media stream; and
the determining a relative delay of the target media stream relative to the first media stream, comprises:
calculating the relative delay of the target media stream relative to the first media stream according to the synchronization information of the target media stream and synchronization information of the first media stream received in advance, wherein, the synchronization information comprises time information in a sender report.

17. The medium according to claim 16, wherein, before the determining a relative delay of the target media stream relative to the first media stream, the method further comprises:
receiving and storing the synchronization information of the first media stream.

18. The medium according to claim 13, wherein, before the receiving a media data packet of a target media stream, the method further comprises:
receiving a data packet of the first media stream, and setting an initial time stamp modifier of the first media stream to 0.

19. The medium according to claim 13, wherein, before the receiving a media data packet of the target media stream, media data packet(s) of one or more media streams has(have) been received.

20. An electronic device, comprising a memory and a processor, the memory having executable code stored therein, and the processor, when executing the executable code, implementing a method for synchronizing multiple media streams, comprising:
determining, in response to receiving a media data packet of a target media stream, an initial time stamp modifier of the media data packet of the target media stream according to a current time stamp modifier of a received first media stream, wherein, the target media stream is a media stream received after the first media stream;
determining a relative delay of the target media stream relative to the first media stream;
updating a time stamp modifier of each received media stream according to the relative delay; and
modifying a time stamp of a data packet of each media stream according to the time stamp modifier of each media stream.

21. The device according to claim 20, wherein, the updating a time stamp modifier of each received media stream according to the relative delay, comprises:
determining a relative size relationship between a delay of the target media stream and a delay of the first media stream according to the relative delay; and
increasing, in response to determining that the delay of the target media stream is less than the delay of the first media stream, a modifier corresponding to the relative delay on a current time stamp modifier of each received media stream other than the target media stream.

22. The device according to claim 21, wherein, the updating a time stamp modifier of each received media stream according to the relative delay, further comprises:
increasing, in response to determining that the delay of the target media stream is greater than the delay of the first media stream, the modifier corresponding to the relative delay on a current time stamp modifier of the target media stream.

23. The device according to claim 20, wherein, the method further comprises:
receiving synchronization information of the target media stream; and
the determining a relative delay of the target media stream relative to the first media stream, comprises:
calculating the relative delay of the target media stream relative to the first media stream according to the synchronization information of the target media stream and synchronization information of the first media stream received in advance, wherein, the synchronization information comprises time information in a sender report.

24. The device according to claim 23, wherein, before the determining a relative delay of the target media stream relative to the first media stream, the method further comprises:
receiving and storing the synchronization information of the first media stream.

25. The device according to claim 20, wherein, before the receiving a media data packet of a target media stream, the method further comprises:
receiving a data packet of the first media stream, and setting an initial time stamp modifier of the first media stream to 0.
